(19) United States
(12) Patent Application Publication
(10) Pub. No.: US 2002/0125389 A1
(43) Pub. Date: Sep. 12, 2002

(54) LEVELING SYSTEM FOR WALL HANGING ITEMS

(76) Inventor: Chia Chen Chu, La Mesa, CA (US)

Correspondence Address: Charles H. Thomas, CISLO & THOMAS LLP, Suite 405, 4201 Long Beach Blvd., Long Beach, CA, 90807-2022, US

(21) Appl. No.: 09/802,561

(22) Filed: Mar. 12, 2001

(51) Int. Cl. E04G 3/08; E06B 7/28; A47G 29/02

(52) U.S. Cl. 248/235

(57) ABSTRACT

A wall hanging support system employs a wall hanging apparatus with a flat elongated body having a cradle at its lower end and an inclined hanger attachment engagement tang at its upper end. At least one fastener extends through the central portion of the body into the wall. A leveling capsule is supported by the cradle beneath the fastener to assist in aligning the wall attachment device in a horizontal orientation. A hanger attachment device is attached to an article, such as a shelf, that is to be hung on the wall. The hanger attachment device has a downwardly inclined wall attachment engaging tang that is inserted in between the wall and the upwardly inclined hanger attachment engagement tang of the wall attachment device.

### BACKGROUND OF THE INVENTION

1. Field of the Invention

The present invention relates to a system for hanging items such as shelves pictures, sconces, mantels, and other wall-mounted structures on a vertical wall in a manner that ensures that these items are mounted level on the wall and for ensuring that such items hang in a horizontal orientation.

2. Description of the Prior Art

Systems exist for supporting wall hanging items in which an extruded metal strip is provided with a central channel that divides the strip into upper and lower legs with a transverse central channel at their junction. The lower leg of the strip lies flush against the wall and is provided with fastener apertures therethrough at transversely spaced periodic intervals. The upper leg extends upwardly and outward from the wall at an angle of between perhaps about five degrees and about twenty degrees. Typically, the upper leg will project outwardly at an angle of about ten degrees relative to the surface of the wall. The strip may be as short as a few inches in length or several feet or longer. The central channel accommodates a short, bubble-type leveling gauge cylinder. One conventional device for hanging pictures which employs a bubble-type leveling gauge is described in U.S. Pat. No. 4,228,982.

The shell of a leveling gauge is formed as a cylinder of transparent plastic, closed at both ends, and containing water that includes an air pocket within the structure of the cylinder. In conventional wall hanging systems the leveling cylinder is positioned in the horizontal channel above the wall fastener apertures and one end or the other of the metal strip is tilted upwardly until the bubble resides in the exact center of the cylinder. The strip is then fastened to the wall with screws or other wall fasteners that project through the fastener openings in the lower leg that resides beneath the leveling indicator channel. Since the lower leg of the strip lies in a vertical plane, flush against the wall, the upper leg projects upwardly from behind the level indicator channel at a slight angle out from the wall.

The structure to be mounted, for example a picture or a shelf, includes a metal mounting bracket fastened to its rear edge. This mounting bracket also has a flat portion with a pair of legs, but in addition includes a central flange that projects downwardly and slightly rearwardly at an angle corresponding to the angle that the horizontally extending upper leg of the wall-mounting strip makes with the wall. The wall hanging mounting bracket has a generally T-shaped configuration, although the central leg of the T is not in perpendicular alignment relative to the remaining portion of the bracket. Rather, it forms an angle with the flat, horizontal portion of the mounting bracket that corresponds to the angle that the upper leg of the wall-mounted support makes with the wall.

The mounting bracket includes fastener openings through which fasteners extend at the rear of the article to be supported from the underside of that article near its rear edge. The central flange of the mounting bracket projects downwardly behind the upper leg of the wall-mounting strip, in between that leg and the wall. Since the upper edge of the wall-mounted strip resides in a horizontal plane, the contact of the mounting bracket against the upper edge of the wall-mounted strip leg holds the top face of the wall-mounting bracket in a horizontal plane also. As a consequence, the structure to be hung is supported in a horizontal disposition.

The problem with conventional supports of this type is that the weight of the article supported from the wall, whether it be a picture, a shelf, or some other structure, acts with a relative long lever arm tending to pull out the fasteners located along the length of the bottom leg of the wall-mounted strip. As a consequence, this substantial leverage due to the force of gravity acting on the bracket or picture can pull the fasteners out of the wall.

### SUMMARY OF THE INVENTION

According to the system of the invention a structure is provided in which the wall anchors are located in the central portion of the wall-mounted strip, rather than in the lower portion. As a consequence, the lever arm of the weight of the picture or shelf which acts upon the fasteners extending into the wall is much shorter than with a conventional system. As a result, there is a considerably reduced tendency for the weight of even a heavy picture or shelf to pull the fasteners out of the wall.

The mounting strip arrangement of the invention still has provision for leveling, however. Since the level indicator channel cannot be formed at the center of the wallmounted strip due to the presence of the wall fastener openings, a generally J-shaped, elongated cradle is formed at the lower extremity of the wall-mounted strip. This cradle supports the level-indicating cylinder in the same manner as in prior art structures, but at the lower extremity of the device, rather than at the center. This allows fasteners to be placed at the center of the strip, or even in a flange extending up against the wall. As a result, a wall-mounted strip having a configuration according to the invention and with fastener openings near its center will support a considerably greater weight than a conventional wall-mounted strip having wall fasteners in its lower leg.

In one broad aspect the present invention may be considered to be a wall hanging apparatus comprising: a wall attachment device, a leveling capsule, a fastener, a hanger attachment device, and a brace member.

The wall attachment device is formed with a longitudinally elongated body having upper and lower ends and a flat wall-facing surface located therebetween. The lower end of the body has a concave upwardly facing cradle. The wall attachment device further includes a hanger attachment engagement tang projecting from the upper end of the body at an inclination away from the flat wall-facing surface.

The leveling capsule contains a liquid and an air bubble therewithin. The capsule is configured for seating in the cradle of the wall attachment device to extend perpendicular to the longitudinal alignment of the body of the wall attachment device. The fastener extends through the body and has a tip protruding from the flat, wallfacing surface and is located between the upper and lower ends of the body.

The hanger attachment device is comprised of a base for fixed engagement to an article to be hung on a wall and a wall attachment tang projecting from the base. The wall attachment engagement tang is oriented to reside at an angle parallel to the hanger attachment engagement tang and is adapted for insertion between the hanger attachment engagement tang and a vertical wall.

The brace member is adapted for permanent attachment to the article to be hung at an outboard location thereon from the hanger attachment device. The brace member projects downwardly and toward the wall and includes a wall-engaging foot that bears against the wall at a location beneath the wall attachment assembly when the wall-engagement tang is inserted between the hanger attachment engagement tang and the wall.

In another aspect the invention may be considered to be a combination of a vertical wall, an article to be hung from the wall, a leveling capsule, a fastener, a wall attachment device, a wall hanging attachment, and a brace. The wall attachment device is formed with a longitudinally elongated, flat central region having a flat, wall-facing surface in contact with the wall. The wall attachment device also has a straight, elongated hangar attachment engaging tang extending from the upper extremity of its central region away from the wall at an acute angle relative thereto. The wall attachment device also has a cradle located at the lower extremity of the central region for providing laterally separated points of support.

The elongated leveling capsule contains a liquid with a bubble of gas entrapped therein. The laterally separated points of support on the cradle provide a seat for the leveling capsule to be supported in a position parallel to the wall and perpendicular to the longitudinal alignment of the central region. The fastener passes through the central region of the wall attachment device and into engagement with the wall.

The wall hanging attachment includes a base attached to the article to be hung at a distance of separation from the wall. It also includes a wall attachment engaging tang protruding downwardly from the base toward the wall at the same acute angle thereto as the hangar attachment engaging tang. The wall attachment engaging tang is inserted between the hanger attachment engaging tang and the wall. The outboard brace extends downwardly from the article to be hung at a location more distant from the wall than the base of the wall hanging attachment. The brace extends toward the wall and into contact therewith beneath the wall attachment assembly.

In still another aspect, the invention may be considered to be a wall hanging apparatus comprising: a wall attachment device, a wall fastener, a level gauge cylinder, a wall hanging article, and an outboard brace. The wall attachment device has a flat central base portion and upper and lower ends longitudinally aligned with the central base portion. The central base portion has a flat wall-facing side and an opposite side. The base portion has an aperture defined therethrough to receive a wall-mounting fastener. The lower end of the wall attachment device is formed as a laterally extending cradle extending outwardly away from the wall-facing side of the base portion. The upper end of the wall attachment device is formed as a straight hanger attachment tang extending outwardly from the opposite side of the central base portion and inclined away from the flat, wall-facing side of the central base portion at an acute angle relative thereto. The wall fastener extends through the aperture in the central base portion of the wall attachment device. The level gauge cylinder is removably seated on the cradle to reside perpendicular to the longitudinal alignment of the portions of the wall attachment device.

The wall hanging article has a flat end residing in coplanar relationship with and above the flat wall-facing side of the central portion of the wall attachment device. The wall hanging article has an underside defining an inclined downwardly and outwardly facing flat bearing surface disposed parallel to the hanger attachment tang. The flat bearing surface of the wall hanging article resides in downwardly bearing contact with the hanger attachment tang of the wall attachment device. The outboard brace extends from the underside of the wall hanging article outboard from the flat bearing surface, downwardly to terminate in a wall-contacting element that is beneath the wall attachment device.

The invention may be described with greater clarity and particularity by reference to the accompanying drawings.

### DESCRIPTION OF THE DRAWINGS

FIG. 1 is a side elevational view of one preferred embodiment of the combination of the invention with components thereof shown prior to full engagement.

FIG. 2 is a side elevational view of the embodiment of FIG. 1 with components thereof shown in full engagement.

FIG. 3 is a front elevational view of the combination of FIG. 2.

FIG. 4 is an enlarged view of a wall attachment device according to the invention shown in isolation from the combination of FIG. 2.

FIG. 5 is a perspective view of the wall attachment device and hanger attachment device shown in FIG. 1.

FIG. 6 is a side elevational detail illustrating an alternative embodiment of the invention.

FIG. 7 is a side elevational view illustrating yet another alternative embodiment of the invention prior to full engagement.

### DESCRIPTION OF THE EMBODIMENTS

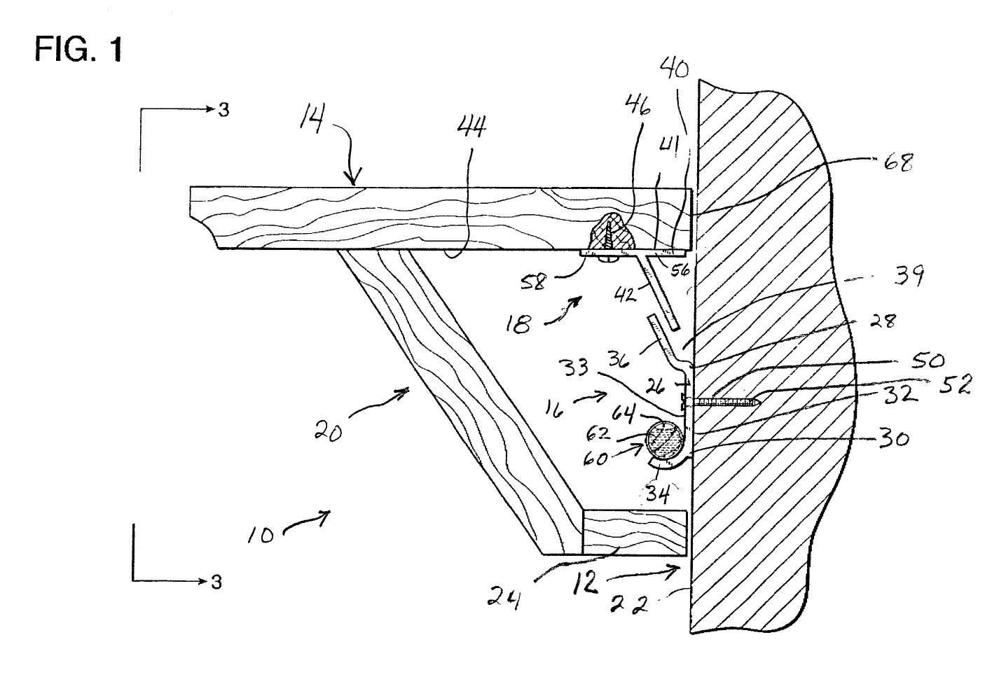

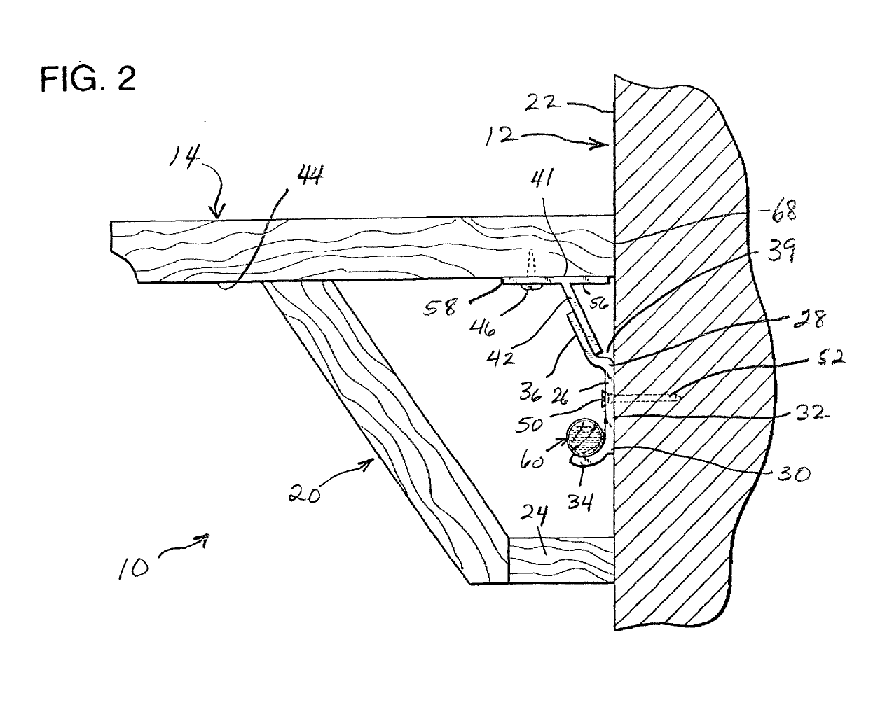

FIGS. 1 and 2 illustrate a wall hanging apparatus generally at 10 in combination with a vertical interior building wall 12 and an article to be hung upon the wall 12, namely a shelf 14. The wall hanging apparatus 10 is comprised of a wall attachment device 16, a hanger attachment device 18, and a brace member 20. The brace member 20 is adapted for permanent attachment to the shelf 14 to be hung. It is secured to the shelf 14 at an outboard location from the hanger attachment device 18, considered relative to the flat, transversely and longitudinally extending vertical surface 22 of the wall 12. The brace member 20 projects at an inclined angle downwardly and toward the wall 12 and includes a wall-engaging foot 24 that bears against the vertical surface 22 of the wall 12 beneath the level of the wall attachment device 16.

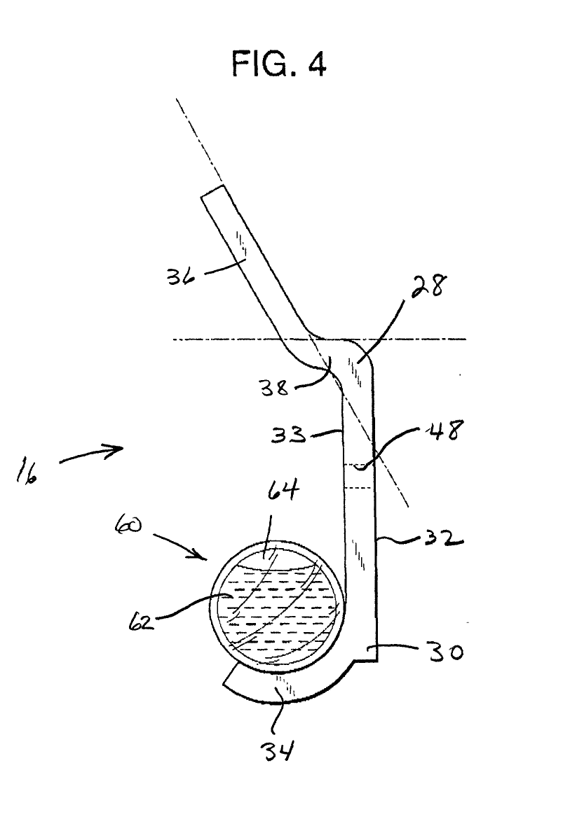

As viewed in side elevation in FIGS. 1, 2, and 4, the wall attachment device 16 is formed with a longitudinally elongated body 26 having an upper end 28, a lower end 30, and a flat, wall-facing surface 32 located therebetween. The body 26 is about twenty-two millimeters in length as measured between its uppermost and lowermost extremities. The body 26 is preferably about 1.5 millimeters in thickness as measured between its vertical, flat, wall-facing surface 32, and its opposing, parallel, outwardly facing flat surface 33 between its upper end 28 and its lower end 30.

Opposite the flat, wall-facing surface 32 the lower end 30 of the body 26 projects outwardly from the surface 33 away from the wall 12 to define a concave, upwardly and outwardly facing cradle 34, preferably curved at a concave radius of four millimeters over an arc of between about one hundred twenty degree and about one hundred seventy five degrees. The distance between the upper end 28 of the body 26 and the commencement of the concave arcuate curvature of the cradle 34 at the lower end 30 of the body 26 is preferably about sixteen millimeters.

The wall attachment device 16 also includes a straight hanger attachment engagement tang 36 that projects from the upper end 28 of the body 26 at an inclination away from the flat wall-facing surface 32. The tang 36 resides at an angle of between about five degrees and about forty degrees relative to the flat wall-facing surface 32, preferably at an angle of about thirty-two degrees relative to the surface 32.

The wall attachment device 16 is further comprised of an intermediate wall set off portion 38 interposed between the upper end 28 of the elongated body 26 and the hanger attachment engagement tang 36 that projects upwardly and outwardly from the elongated body 26. The intermediate portion 38 extends horizontally slightly so as to define a gap 39 between the lower extremity of the hanger attachment engagement tang 36 and the upper end 28 of the elongated body 26. The hanger attachment engagement tang 36 is preferably eleven millimeters in length as measured from its upper tip to its junction with the intermediate portion 38.

As illustrated in FIGS. 1 and 2, the hanger attachment device 18 is comprised of a base 40 having a flat, upper surface 41 and a straight wall attachment tang 42. The base 40 is disposed in fixed engagement to the shelf 14 and the wall attachment engagement tang 42 projects downwardly from the base 40 and is oriented to reside at an inclined angle relative to the base 40 and parallel to the hanger attachment engagement tang 36. The wall attachment engagement tang 42 is adapted for insertion between the hanger attachment engagement tang 36 and the vertical surface 22 of the flat vertical wall 12. The base 40 of the wall hanging attachment 18 extends from beyond the distance of separation defined by its junction with the tang 42 into close proximity to the surface 22 of the wall 12. The wall attachment engaging tang 42 intersects the base 40 of the wall hanging attachment 18 between the extremities of the base 40.

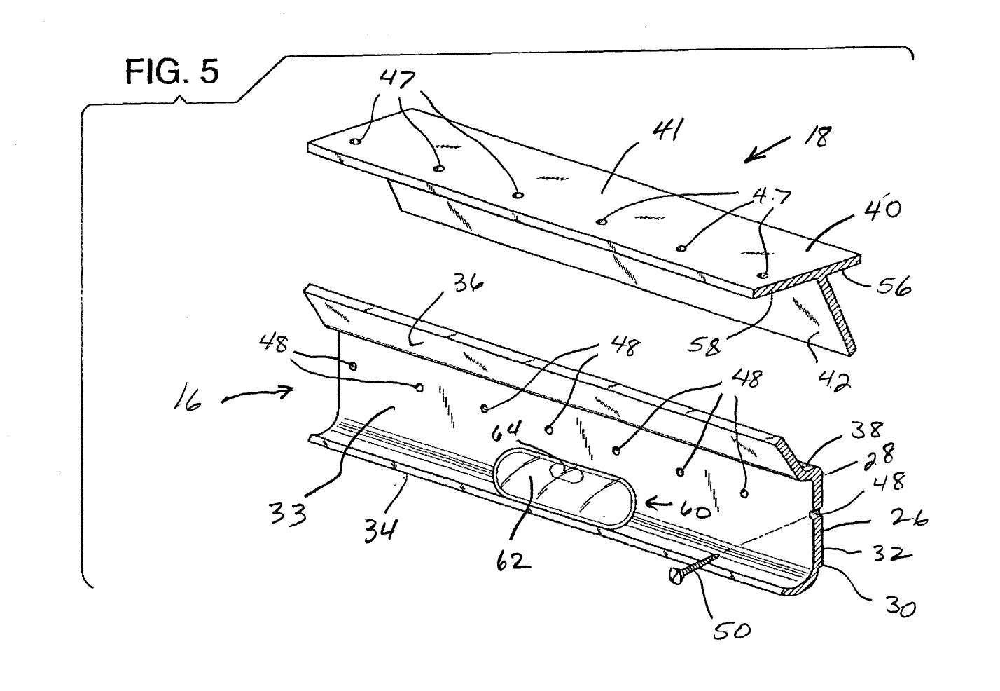

The width of both the wall attachment device 16 and the hanger attachment device 18 as measured in a transverse, horizontal direction parallel to the flat surface 22 of the wall 12 is quite variable and is selected in accordance with the width of the shelf 14, or other article to be hung from the wall 12. Preferably, both the wall attachment device 16 and the hanger attachment device 18 are formed from extruded metal or plastic stock, and are of uniform cross section throughout as viewed in a plane perpendicular to the vertical flat surface 22 of the wall 12, and as illustrated in drawing FIGS. 1, 2, and 4. The extruded stock is cut to the appropriate length to form the wall attachment device 16 and the hanger attachment device 18. Lengths of the wall attachment device 16 and the hanger attachment device 18 are illustrated in separation from each other in the perspective view of FIG. 5.

The base 40 is perforated with openings 47 to receive shelf fastening screws 46 at intervals about three inches apart. Likewise, openings 48 are formed through the structure of the body 26 and extend between the flat surfaces 32 and 33 thereof to receive wall fastening screws 50. The wall attachment device 16 and the hanger attachment device 18 are both cut long enough so that there is at least one opening 47 in the base 40 of the hanger attachment device 18 and at least one opening 48 in the wall attachment device 16. The hanger attachment device 18 is secured to the underside 44 of the shelf 14 by at least one screw 46. The number of screws 46 employed will depend upon the width of the shelf 14. Each opening 48 is located at the longitudinal, that is, vertical center of the body 26, between the upper and lower ends 28 and 30.

A wall fastening screw 50 extends through the body 26 at each opening 48. Each fastener 50 has a tip 52 that protrudes and penetrates into the wall 12 from the flat wall-facing surface 32 of the body 26.

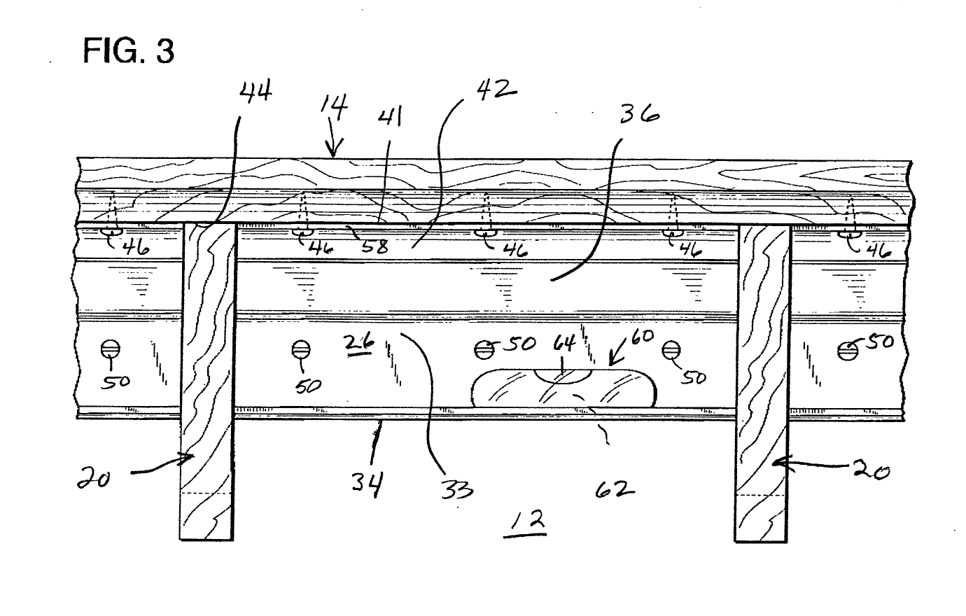

In the embodiment of FIGS. 1-5 the flat base 40 of the hanger attachment device 18 has both an inboard portion 56 and an outboard portion 58 which extend in opposing directions from a junction with the wall attachment engagement tang 42. The base portions 56 and 58 reside in coplanar relationship with each other and in an orientation perpendicular to the longitudinal (vertical) orientation of the elongated body 26 of the wall attachment device 16. The wall attachment engaging tang 42 protrudes downwardly from the demarcation between the base portions 56 and 58 of the base 40 at a spaced distance of separation from the wall surface 22. Typically the junction between the wall attachment engaging tang 42 and the base 40 is spaced a distance of between about one half of an inch and about two inches from the vertical surface 22 of the wall 12.

The wall hanging apparatus 10 also includes a leveling capsule 60 that is formed of a transparent glass or plastic shell that encases a liquid 62 and an air bubble 64 therewithin, as illustrated in FIGS. 1-3 and 5. The wall attachment device 16 may be rather thin, but must be wide enough in a transverse direction parallel to the wall surface 22 and perpendicular to the longitudinal vertical alignment of the body 26 to provide laterally separated points of support on the cradle 34 for the leveling capsule 60. This allows the cradle 34 to support the leveling capsule 60 in a position parallel to the wall surface 22 and perpendicular to the longitudinal alignment of the central region, that is, the body 26, and also the alignment of the upper and lower body ends 28 and 30.

To utilize the wall hanging apparatus 10 the width of the shelf 14, or other article to be hung, is first measured. The wall attachment device 16 and the hanger attachment device 18 are then cut from extruded stock to a length no greater than the width of the shelf 14. The hanger attachment device 18 is then placed against the undersurface 44 of the shelf 14 taking care to ensure that the junction between the wall attachment engagement tang 42 and the base 40 is at the same distance from the rear edge surface 68 of the shelf 14 throughout the length of the hanger attachment device 18. Screws 46 are then inserted into each of the spaced openings defined along the stock forming the hanger attachment device 18. The screws 46 secure the hanger attachment device 18 to the underside 44 of the shelf 14.

The location on the surface 22 of the wall 12 is then selected at which the shelf 14 is to be hung. The wall attachment device 16 is then positioned so that the flat wallfacing surface 32 of the base 26 resides in contact with the wall surface 22 at the selected level above the floor of the room in which the shelf 14 is to be hung. The leveling capsule 60 is then placed in the cradle 34 and the longitudinal extremities of the wall attachment device 16 are then raised or lowered until the bubble 64 resides at the exact center of the leveling capsule 60. Fastening screws 50 are then directed through the openings 48 defined in the base 26 of the wall attachment device 16 so as to secure the wall attachment device 16 firmly against the vertical surface 22 of the wall 12 and in a horizontal orientation.

The shelf 14 is then positioned with its rear edge surface 68 in close proximity to the wall surface 22 and with the hanger attachment device 18 located slightly above the wall attachment device 16, as illustrated in FIG. 1. The shelf 14 is then lowered downwardly to the position shown in FIG. 2. In this position the wall attachment engaging tang 42 protrudes downwardly from the base 40 towards the wall 12 at the same acute angle relative thereto as the hanger attachment engaging tang 36. The wall attachment engaging tang 42 is thereby inserted between the hanger attachment engaging tang 36 and the wall 12. At the same time the foot 24 of the brace 20 bears against the wall 12 at a location beneath the vertical level of the wall attachment device 16. The interengagement between the tangs 42 and 36 thereby holds the shelf 14 in a perfectly horizontal orientation and perpendicular to the wall surface 22.

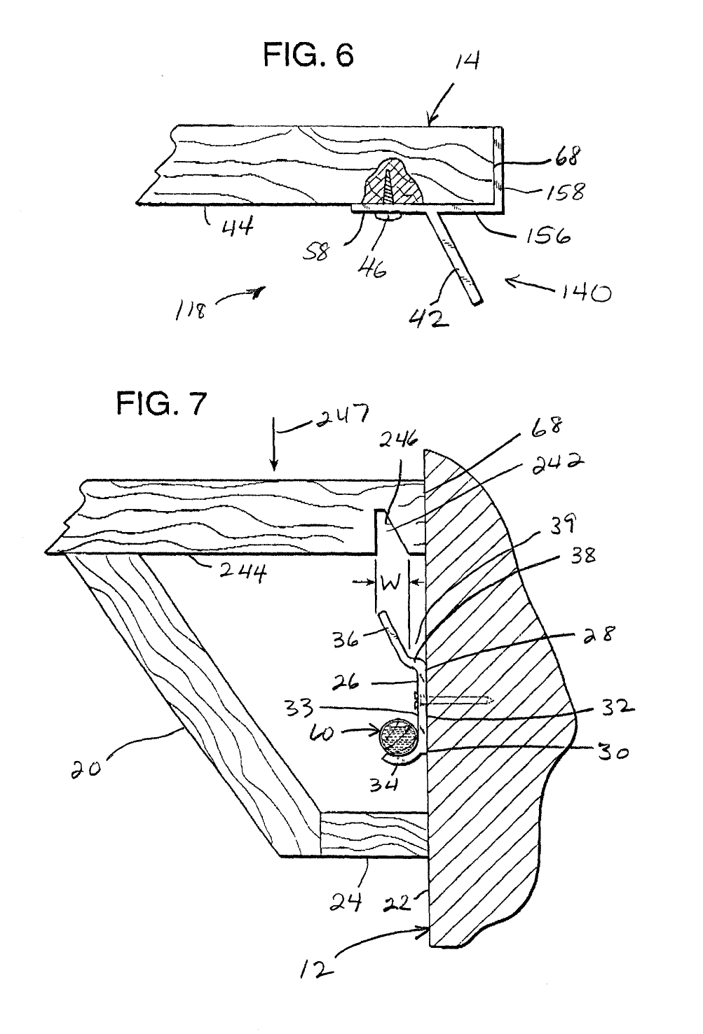

FIG. 6 illustrates an alternative embodiment of a hanger attachment device 118 that may be utilized according to the invention. The hanger attachment device 118 has a wall attachment engagement tang 42 that projects downwardly and toward the wall 12 as previously described. The base 140 of the hanger attachment device 118 has an outboard projecting portion 58 with apertures to receive fastening screws 46, as in the embodiment shown in drawing FIGS. 1-5. However, the inboard portion 156 of the base 140 extends all the way to the rear edge surface 68 of the shelf 14 and has an upturned foot 158 at the inboard extremity of the base 140. The upturned foot 158 is a flat, thin flange that extends away from and resides in longitudinal alignment with the longitudinally elongated body 26 of the wall attachment device 16. The hanger attachment device 118 is advantageous in that its right angle shape at its inboard end forms a pocket to receive the rear edge surface 68 of the shelf 14. The rear edge surface 68 thereby resides in abutment against the upturned foot 158. This ensures that the distance from the wall surface 22 and the junction between the wall attachment engagement tang 42 and the base 140 is uniform throughout the width of the shelf 14. As a consequence, intimate contact is assured between the tangs 36 and 42 throughout the length of the structures forming the wall attachment device 16 and the hanger attachment device 18.

FIG. 7 illustrates another embodiment of the invention which does not require a hanger attachment device separate from the shelf itself. In this embodiment, the shelf 214 has a flat end surface 68 that resides in coplanar relationship with and above the flat wall-facing surface 32 of the central body portion 26 of the wall attachment device 16. A slot 242 is formed in the underside 244 of the shelf 214. One of the opposing lateral walls of the slot 242 defines an inclined downwardly and outwardly facing flat bearing surface 246 disposed parallel to the hanger attachment tang 36. The straight hanger attachment tang 36 projects up into the slot 242 and resides in intimate contact with the slot wall bearing surface 246 throughout when the shelf 214 is lowered into position.

As illustrated, the slot 242 has a width at least as great as the length of projection of the hanger attachment tang 36 onto a plane perpendicular to the longitudinal, vertical alignment of the central base portion 26 and the upper and lower ends 28 and 30 of the wall attachment device 16. This length of projection of the hanger attachment tang 36 is indicated by the distance W in FIG. 7.

Stated another way, the slot 242 has a width W at the undersurface 244 at least as great as the sine of the acute angle of inclination of the tang 36 and bearing surface 246 relative to the wall 12 multiplied by the length of the hanger attachment tang 36. That is, in the preferred embodiment of the invention the width W of the slot 242 at the undersurface 244 is about 5.28 mm. As a consequence, the rear edge surface 68 of the shelf 214 can be moved into contact with the wall surface 22 and the shelf 214 can be lowered directly downwardly as indicated by the directional arrows 247 until the tang 36 engages the bearing surface 246. The remaining structure of the combination of the shelf, the wall and the wall hanging apparatus in the embodiment of FIG. 7 is the same as that illustrated in drawing FIGS. 1-5.

Undoubtedly, numerous variations and modifications of the invention will become readily apparent to those familiar with systems for hanging articles from walls and for ensuring that those articles are hung level. Accordingly, the scope of the invention should not be construed as limited to the specific embodiments depicted and described, but rather is defined in the claims appended hereto.

I claim:

1. A wall hanging apparatus comprising:
a wall attachment device formed with a longitudinally elongated body having upper and lower ends and a flat wall-facing surface located therebetween, wherein said lower end of said body has a concave outwardly facing cradle, and said wall attachment device further includes a hanger attachment engagement tang projecting from said upper end of said body at an inclination away from said flat wall-facing surface,
an elongated enclosed leveling capsule containing a liquid and an air bubble therewithin and configured for seating in said cradle to extend perpendicular to the longitudinal alignment of said body,
a fastener extending through said body and having a tip protruding from said flat wall-facing surface and located between said upper and lower ends of said body,
a hanger attachment device comprising a base for fixed engagement to an article to be hung on a wall and a wall attachment engagement tang projecting from said base and oriented to reside at an angle parallel to said hanger attachment engagement tang and adapted for insertion between said hanger attachment engagement tang and a vertical wall, and
a brace member adapted for permanent attachment to said article to be hung at an outboard location thereon from said hanger attachment device and projecting downwardly and toward said wall and including a wall-engaging foot that bears against said wall at a location beneath said wall attachment device when said wall attachment engagement tang is inserted between said hanger attachment engagement tang and said wall.

2. A wall hanging apparatus according to claim 1 wherein said base of said hanger attachment device forms a junction with said wall attachment engagement tang and extends both inboard and outboard from said junction in an orientation perpendicular to the longitudinal orientation of said elongated body of said wall attachment device.

3. A wall hanging apparatus according to claim 2 wherein said hanger attachment device has an upturned foot at the inboard extremity of its base, and said upturned foot extends away from and resides in coplanar relationship with said longitudinally elongated body of said wall attachment device.

4. A wall hanging apparatus according to claim 1 wherein said wall attachment device is further comprised of an intermediate wall set off portion interposed between said upper end of said elongated body and said hanger attachment tang that projects outwardly from said elongated body to define a gap between the lower extremity of said hanger attachment engagement tang and said upper end of said elongated body.

5. A wall hanging apparatus according to claim 1 wherein both of said tangs reside at an angle of between about five degrees and about forty degrees relative to said flat wall-facing surface of said elongated body of said wall attachment device.

6. A wall hanging apparatus according to claim 5 wherein both of said tangs reside at an angle of about thirty-two degrees relative to said flat wall-facing surface of said elongated body of said wall attachment device.

7. In combination, a vertical wall, an article to be hung from said wall, and a wall hanging device comprising:
a wall attachment device formed with a longitudinally elongated flat central region having a flat, wall-facing surface in contact with said wall, a straight, elongated hanger attachment engaging tang extending from the upper extremity of said central region away from said wall at an acute angle relative thereto, and a cradle located at the lower extremity of said central region for providing laterally separated points of support,
an elongated leveling capsule containing a liquid with a bubble of gas entrapped therein, and said laterally separated points of support on said cradle provide a seat for said leveling capsule to support it in a position parallel to said wall and perpendicular to the longitudinal alignment of said central region,
a fastener that passes through said central region of said wall attachment device and into engagement with said wall,
a wall hanging attachment including a base attached to said article to be hung and a wall attachment engaging tang protruding downwardly from said base at a distance of separation from said wall and toward said wall at the same aforesaid acute angle thereto as said hanger attachment engaging tang, and said wall attachment engaging tang is inserted between said hanger attachment engaging tang and said wall, and
an outboard brace extending downwardly from said article to be hung at a location more distant from said wall than said base of said wall hanging attachment, and said brace extends toward said wall and into contact therewith beneath said wall attachment device.

8. A combination according to claim 7 wherein said base of said wall hanging attachment extends from beyond the aforesaid distance of separation from said wall into close proximity to said wall, and said wall attachment engaging tang intersects said base of said wall hanging attachment between the extremities of said base.

9. A combination according to claim 7 wherein said base of said wall hanging attachment extends from beyond the aforesaid distance of separation from said wall all the way to said wall and upwardly into contact therewith with a wall-contacting surface parallel to and in coplanar relationship with said flat, wall-facing surface of said central region of said wall attachment device.

10. A combination according to claim 7 wherein said acute angle is between about five degrees and about forty degrees.

11. A combination according to claim 10 wherein said acute angle is about thirty-two degrees.

12. A combination according to claim 7 wherein said wall attachment device is formed with a transition region at said upper extremity that extends outwardly from said central region in a direction perpendicular to said wall to form a junction with the lower extremity of said hanger attachment engaging tang and to define a gap between said lower extremity of said hanger attachment engaging tang and said wall.

13. A wall hanging apparatus comprising:
a wall attachment device having a flat central base portion and upper and lower ends longitudinally aligned with said central base portion, and said central base portion has a flat wall-facing surface and an opposite surface and an aperture defined therethrough to receive a wall-mounting fastener, said lower end is formed as a laterally extending cradle extending outwardly away from said wall-facing surface of said base portion, and said upper end is formed as a straight hanger attachment tang extending outwardly from said opposite surface of said central base portion and inclined away from said flat wall-facing surface of said central base portion at an acute angle relative thereto,
a wall fastener extending through said aperture in said central base portion of said wall attachment device,
a level gauge cylinder removably seated on said cradle to reside perpendicular to the longitudinal alignment of said portions of said wall attachment device,
a wall hanging article having a flat end residing in coplanar relationship with and above said flat wall-facing surface of said central portion of said wall attachment device and an underside defining an inclined downwardly and outwardly facing flat bearing surface disposed parallel to said hanger attachment tang, whereby said flat bearing surface of said wall hanging article resides in downwardly bearing contact with said hanger attachment tang of said wall attachment device, and
an outboard brace extending from said underside of said wall hanging article outboard from said flat bearing surface downwardly to terminate in a wall-contacting element that is beneath said wall attachment device.

14. A wall hanging apparatus according to claim 13 wherein a slot having opposing lateral walls is formed in said underside of said wall hanging article, and one of said opposing lateral walls of said slot forms said inclined downwardly and outwardly facing flat bearing surface, and said straight hanger attachment tang projects up into said slot.

15. A wall hanging apparatus according to claim 14 wherein said slot has a width at least as great as the length of projection of said hanger attachment tang onto a plane perpendicular to said central base portion of said wall attachment device and perpendicular to the longitudinal alignment of said central base portion and said upper and lower ends of said wall attachment device.

16. A wall hanging apparatus according to claim 14 wherein said slot has a width at least as great as the sine of said acute angle multiplied by the length of said hanger attachment tang.
